(19) United States
(12) Patent Application Publication
(10) Pub. No.: US 2023/0192015 A1
(43) Pub. Date: Jun. 22, 2023

(54) BUSBAR CONNECTOR ASSEMBLY FOR ELECTRIC VEHICLE

(71) Applicant: Lordstown EV Corporation, Lordstown, OH (US)

(72) Inventor: Aaron Smith, Lordstown, OH (US)

(73) Assignee: Lordstown EV Corporation, Lordstown, OH (US)

(21) Appl. No.: 18/069,111

(22) Filed: Dec. 20, 2022

Related U.S. Application Data
(60) Provisional application No. 63/292,152, filed on Dec. 21, 2021.

(51) Int. Cl. B60R 16/02; H02J 7/00; H01R 13/52; H01R 4/2495; H02G 5/04; B60L 50/60; B60K 7/00; H01M 50/204; H01M 50/249; H01M 50/298

(52) U.S. Cl. CPC B60R 16/0215; H02J 7/0063; H01R 13/5202; H01R 4/2495; H02G 5/04; B60L 50/60; B60K 7/0007; H01M 50/204; H01M 50/249; H01M 50/298; H02J 2207/20; H01R 2201/26; H01M 2220/20

(57) ABSTRACT

An electric vehicle includes at least one tractive element, a battery pack including a plurality of battery cells, an in-wheel hub motor coupled to the at least one tractive element and electrically coupled to the battery pack, and a busbar assembly configured to electrically couple the motor to the battery pack. The busbar assembly can include a busbar, a cable electrically coupled to the busbar, and an inverter electrically coupled to the cable and configured to convert power supplied from the battery pack to the motor. The busbar assembly further includes a bracket configured to mount the cable to a knuckle of the electric vehicle and position the cable at a fixed or variable angle.

### CROSS-REFERENCE TO RELATED APPLICATIONS

The present application claims priority to U.S. Provisional Application No. 63/292,152 filed Dec. 21, 2021, the entire contents of which are incorporated herein by reference.

### BACKGROUND

The present disclosure relates generally to the field of electrical connectors for vehicles. More specifically, the present disclosure relates to a busbar connector that is mounted onto an electric vehicle.

### SUMMARY

One exemplary embodiment relates to an electric vehicle. The electric vehicle can include at least one tractive element, a battery pack including a plurality of battery cells, a motor coupled to the at least one tractive element and electrically coupled to the battery pack, and a busbar assembly configured to electrically couple the motor to the battery pack. The busbar assembly can include a busbar, a cable electrically coupled to the busbar, and an inverter electrically coupled to the cable and configured to convert power supplied from the battery pack to the motor. The busbar assembly can include a bracket configured to mount the cable to a knuckle of the electric vehicle and position the cable at a fixed or variable angle.

The busbar assembly can include at least one crimp coupled to at least one portion of the cable. The at least one crimp can be configured to isolate the at least one portion of the cable from direct contact with a plurality of components of the electric vehicle to prevent axial load damage.

The busbar assembly can include an outboard housing coupled to the motor, the outboard housing comprising at least one cavity configured to position the busbar for coupling with the motor, and an inboard housing coupled to the outboard housing. The busbar can be interposed between the outboard housing and the inboard housing. A proximal end of the cable can be positioned laterally from the outboard housing and the inboard housing by a perpendicular extension of the busbar.

The busbar assembly can include a first seal coupled to the outboard housing and configured to surround the busbar, wherein the first seal defines an opening of the at least one cavity of the outboard housing, and a second seal coupled to the first seal and configured to encapsulate the busbar with the first seal. The busbar assembly can include at least one conductive o-ring coupled to a portion of the cable and positioned proximate to the busbar.

The electric vehicle can include a motor connection port configured to interface with the busbar assembly. The busbar assembly can include a conductive gasket having an opening surrounding the motor connection port. The conductive gasket can be interposed between the motor and at least one of an outboard housing or an inboard housing.

The motor can be a three-phase motor having a three-phase cable system. The busbar assembly can include a plurality of cables coupled to a plurality of busbars, respectively, configured to electrically couple the motor to the three-phase cable system of the three-phase motor. The three-phase cable system can include a rigid cable shield configured to insulate the plurality of cables from one another.

Another exemplary embodiment relates to a busbar assembly. The busbar assembly can include a plurality of busbars, a plurality of cables electrically respectively coupled to the plurality of busbars, and an inverter electrically coupled to the plurality of cables. The busbar assembly can be configured to electrically couple a motor to a battery pack of an electric vehicle. The inverter can be configured to convert power supplied from the battery pack to the motor.

The busbar assembly can include a bracket configured to mount the plurality of cables to a knuckle of the electric vehicle and position the plurality of cables at a fixed angle. The busbar assembly can include a plurality of crimps coupled to at least one portion of the plurality of cables. One or more of the plurality of crimps can be configured to isolate the at least one portion of the plurality of cables from direct contact with a plurality of components of the electric vehicle to prevent axial load damage.

Yet another exemplary embodiment relates to a method. The method can include coupling a busbar assembly to a battery pack of an electric vehicle. The method can include coupling the busbar assembly to a motor of the electric vehicle. The motor and the battery pack can be electrically coupled via the busbar assembly. The busbar assembly can include a busbar, a cable electrically coupled to the busbar, and an inverter electrically coupled to the cable and configured to convert power supplied from the battery pack to the motor.

The method can include coupling at least one crimp to at least one portion of the cable. The at least one crimp can be configured to isolate the at least one portion of the cable from direct contact with a plurality of components of the electric vehicle to prevent axial load damage.

The invention may be implemented with other embodiments and carried out in various ways. Alternative exemplary embodiments relate to other features and combinations of features as may be recited herein.

### BRIEF DESCRIPTION OF THE FIGURES

FIG. 1 is a side view of an electric vehicle, according to an exemplary embodiment;

FIG. 2 is a diagram of an electrical system of FIG. 1, according to an exemplary embodiment;

FIG. 3 is a perspective view of a busbar connector assembly in the electrical system of FIG. 1, according to an exemplary embodiment;

FIG. 4 is a perspective view of a front of the busbar connector assembly of FIG. 3, according to an exemplary embodiment;

FIG. 5 is a perspective view of a rear of the busbar connector assembly of FIG. 3, according to an exemplary embodiment;

FIG. 6 is a perspective view of the suspension system of FIG. 1, showing the busbar connector assembly coupled to the knuckle, according to an exemplary embodiment;

FIG. 7 is a perspective view of a busbar connector assembly, according to an exemplary embodiment;

FIG. 8 is another perspective view of the busbar connector assembly of FIG. 7, according to an exemplary embodiment;

FIG. 9 is a perspective view of a bracket of the busbar connector assembly of FIG. 7, according to an exemplary embodiment;

FIG. 10 is a perspective view of one or more crimps used on the bracket of FIG. 9, according to an exemplary embodiment;

FIG. 11 is a perspective view of one or more crimps without the bracket of FIG. 9, according to an exemplary embodiment;

FIG. 12 is a perspective view of an inboard housing of the busbar connector assembly of FIG. 7, according to an exemplary embodiment;

FIG. 13 is a perspective view of fasteners used on the busbar connector assembly of FIG. 7, according to an exemplary embodiment;

FIG. 14 is a perspective view of the inboard housing separated from the outboard housing of the busbar connector assembly of FIG. 7, according to an exemplary embodiment;

FIG. 15 is a perspective view of the outboard housing of the busbar connector assembly of FIG. 7, according to an exemplary embodiment;

FIG. 16 is a perspective view of inboard seals separated from the outboard housing of the busbar connector assembly of FIG. 7, according to an exemplary embodiment;

FIG. 17 is a perspective view of individual busbars of the busbar connector assembly of FIG. 7, according to an exemplary embodiment;

FIG. 18 is a perspective view of fasteners of the busbars of the busbar connector assembly of FIG. 7, according to an exemplary embodiment;

FIG. 19 is another perspective view of the busbars of the busbar connector assembly of FIG. 7, according to an exemplary embodiment;

FIG. 20 is a perspective view of the busbars separated from motor connection ports of the electrical system of FIG. 1, according to an exemplary embodiment;

FIG. 21 is a perspective view of cavities exposing the motor connection ports of the electrical system of FIG. 1, according to an exemplary embodiment;

FIG. 22 is a perspective view of outboard seals used on the outboard housing of FIG. 14, according to an exemplary embodiment;

FIG. 23 is a perspective view of the busbar connector assembly of FIG. 7 without the outboard seals, according to an exemplary embodiment;

FIG. 24 is a perspective view of fasteners used on the outboard housing of FIG. 14, according to an exemplary embodiment;

FIG. 25 is a perspective view of the outboard housing separated from a conductive gasket of the busbar connector assembly of FIG. 7, according to an exemplary embodiment; and

FIG. 26 is a perspective view of the conductive gasket separated from the motor connection ports of FIG. 20, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, the various exemplary embodiments disclosed herein relate to systems, apparatuses, and methods for busbar connectors mounted onto electric vehicles. An electric vehicle can include at least a chassis, tractive elements coupled to the chassis, at least one battery pack located within the chassis at any suitable position, and at least one busbar connector assembly electrically coupled to the battery pack and the respective in-wheel motor of the electric vehicle.

The busbar connector assembly can include various components or structures. For example, the busbar connector assembly can include a bracket configured to mount a cable to a knuckle of the electric vehicle and position the cable at a fixed angle. The busbar assembly can include at least one crimp coupled to at least one portion of the cable. The at least one crimp can be configured to isolate the at least one portion of the cable from direct contact with a plurality of components of the electric vehicle to prevent axial load damage.

Further, the busbar assembly can include an outboard housing coupled to the motor, the outboard housing comprising at least one cavity configured to position the busbar for coupling with the motor, and an inboard housing coupled to the outboard housing. The busbar can be interposed between the outboard housing and the inboard housing. A proximal end of the cable can be positioned laterally from the outboard housing and the inboard housing by a perpendicular extension of the busbar.

In some embodiments, the busbar assembly can include a first seal coupled to the outboard housing and configured to surround the busbar, wherein the first seal defines an opening of the at least one cavity of the outboard housing, and a second seal coupled to the first seal and configured to encapsulate the busbar with the first seal. The busbar assembly can include at least one conductive o-ring coupled to a portion of the cable and positioned proximate to the busbar.

The electric vehicle can include a motor connection port configured to interface with the busbar assembly. The busbar assembly can include a conductive gasket having an opening surrounding the motor connection port. The conductive gasket can be interposed between the motor and at least one of an outboard housing or an inboard housing.

The motor can be a three-phase motor having a three-phase cable system. The busbar assembly can include a plurality of cables coupled to a plurality of busbars, respectively, configured to electrically couple the motor to the three-phase cable system of the three-phase motor. The three-phase cable system can include a rigid cable shield configured to insulate the plurality of cables from one another.

### Overall Vehicle

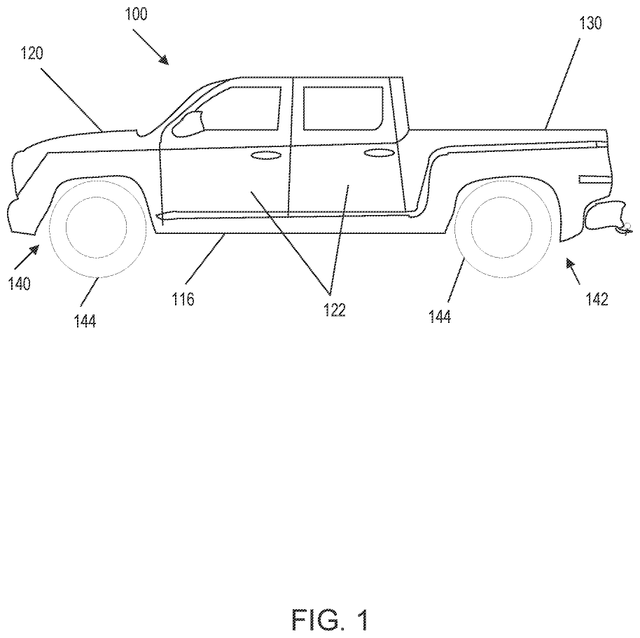

According to the exemplary embodiment shown in FIG. 1, a vehicle 100, such as an electric vehicle, can include a chassis supporting the structure or a body assembly of the vehicle 100 including a front portion 120, a rear portion 130, or other portions of vehicle 100. The various portions of the vehicle 100 may be referred to as a first portion (e.g., front portion 120), a second portion (e.g., rear portion 130), etc. As shown in FIG. 1, the front portion 120 is a truck cab and the rear portion 130 is a truck bed, where the truck bed is positioned rearward the truck cab. According to an exemplary embodiment, the vehicle 100 is an electric truck. In other embodiments, the vehicle 100 may be an electric vehicle such as an electric utility vehicle, an electric recreational off-highway vehicle, an electric hybrid all-terrain vehicle, an electric sport utility vehicle, an electric van or other type of short or long-haul transportation or freight moving vehicle. The vehicle 100 can be an electric vehicle for government and/or military applications, and/or for other applications. In still other embodiments, the vehicle 100 may be a hybrid vehicle such as a hybrid utility vehicle, a hybrid recreational off-highway vehicle, a hybrid all-terrain vehicle, a hybrid sport utility vehicle, and/or still another hybrid vehicle.

The chassis can define a longitudinal axis that may be generally aligned with a frame rail of the chassis of the vehicle 100 (e.g., front-to-back, etc.). In some embodiments, the vehicle 100 can include a plurality of front tractive assemblies 140 and/or a plurality of rear tractive assemblies 142 (e.g., two assemblies at the front of the vehicle 100 and two at the rear of the vehicle 100, etc.). The front tractive assemblies 140 and/or the rear tractive assemblies 142 may include brakes (e.g., disc brakes, drum brakes, air brakes, etc.), gear reduction mechanisms, steering components, wheel hubs, wheels, tires, and/or other features. As shown in FIG. 1, the front tractive assemblies 140 and the rear tractive assemblies 142 each include tractive elements, shown as wheel and tire assemblies 144. In other embodiments, at least one of the front tractive assemblies 140 and the rear tractive assemblies 142 include a different type of tractive element (e.g., a track, etc.). By way of example, the front tractive assemblies 140 may include a front axle extending centrally between each of the front tractive assemblies 140 and the rear tractive assemblies 142 may include a rear axle extending centrally between each of the rear tractive assemblies 142.

According to an exemplary embodiment, the front portion 120 includes one or more doors. The interior of the front portion 120 may include seats, vehicle controls, driving components (e.g., steering wheel, accelerator pedal, brake pedal, etc.), at least one user interface, and other components. According to the exemplary embodiment shown in FIG. 1, the rear portion 130 includes a truck bed or a flat bed where the truck bed is configured to hold or transport various contents.

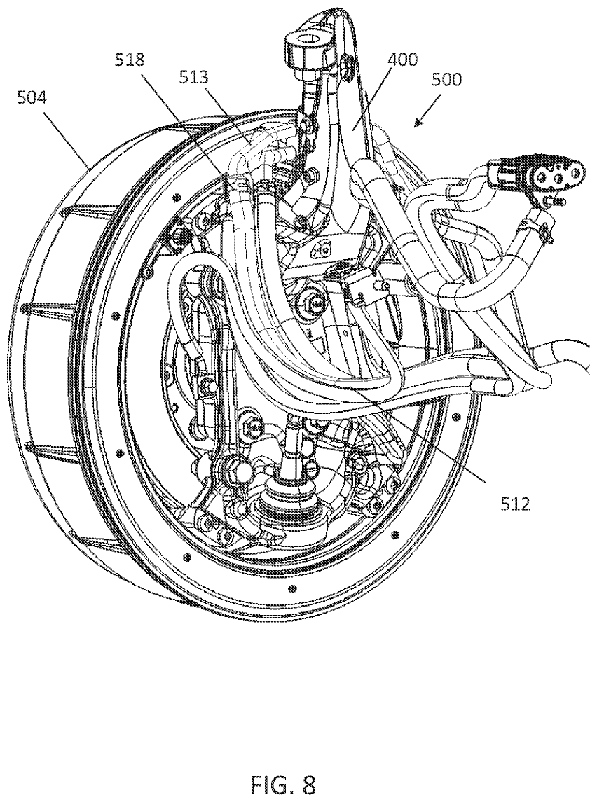

In various embodiments, the vehicle 100 can include one or more electric motors (e.g., shown as motor 504 in at least FIG. 8). The electric motors can be in-wheel hub motors configured to control the drive and/or torque of respective tractive elements (e.g., wheels). For example, the vehicle 100 can include at least four electric motors, each coupled to a respective tractive element 140, 142 (140a, 140b, 142a, and 142b). In some cases, the electric motor can be a part of the tractive assemblies 140 or the tractive elements. By way of example, a first motor can be electrically coupled to the first front tractive elements 140a, a second motor can be electrically coupled to the second front tractive elements 140b, a third motor can be electrically coupled to the first rear tractive elements 142a, and a fourth motor can be electrically coupled to the second rear tractive elements 142b.

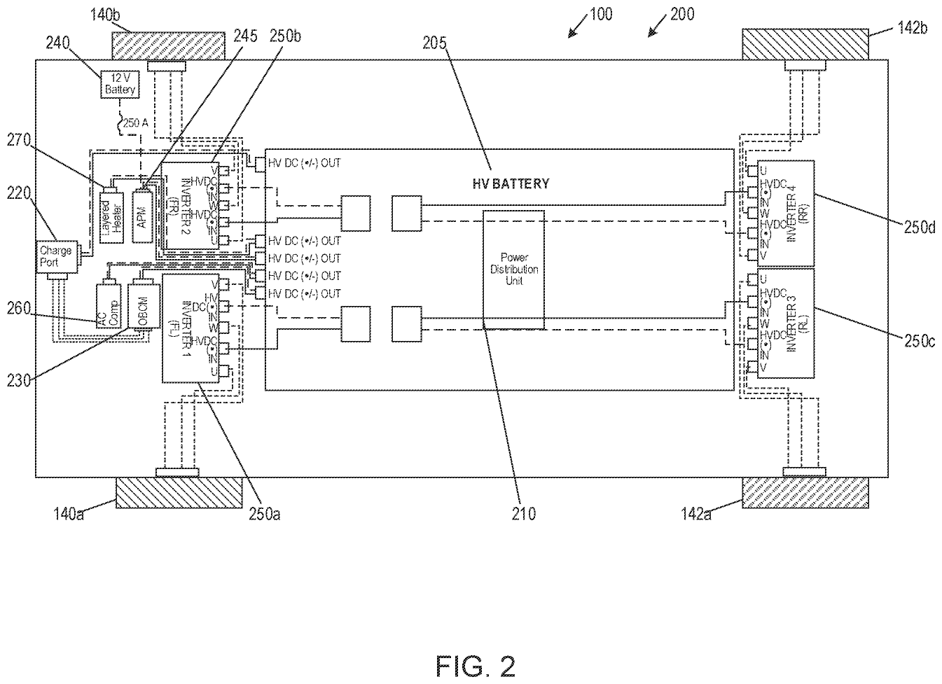

Still referring to FIG. 1, the chassis can include one or more busbar connector assemblies 300. The busbar connector assemblies 300 can include one or more cables 316 or wirings. The cable 316 can provide an electrical connection and/or mechanical connection between components of the vehicle 100, such as the electric motor or other electrical components, and at least one battery pack (e.g., battery pack 205 as described below in conjunction with at least FIG. 2). The electrical coupling between the battery pack 205 and the vehicle 100 will be described further herein. Various cables 316 can couple the battery pack 205 to the one or more electric motors. In some embodiments, the battery pack 205 can be removably coupled to the one or more electric motors by the respective cable 316 to allow the battery pack 205 to be changed with another battery pack 205. For example, the cable 316 may include a quick connector that holds the battery pack 205 in place during operation of the vehicle 100. The quick connector may then be actuated (e.g., moved, opened, driven, operated, etc.) to allow the battery pack 205 to be decoupled to the vehicle 100. In some embodiments, the battery pack 205 is removably coupled to the respective cable 316 through one or more fasteners (e.g., a bolt, etc.). In even other embodiments, a frame of the battery pack 205 includes a first connector (e.g., a plastic extension, a threaded end, etc.) that connects into a second connector (e.g., a slit, an opening, a threaded hole, etc.) of the respective cable 316 through an electrical connection (e.g., one or more wires, a male electrical connection, etc.).

As described herein, the cable 316 can be electrically coupled to a single battery pack 205, where the battery pack 205 may be centrally located between a first front tractive element 140a and a second front tractive element 140b, such as shown in conjunction with FIG. 2. In some embodiments, the cable 316 may be electrically coupled to multiple battery packs, each of which may be variously positioned within the chassis of the vehicle 100, such as centered, offset from the central position between the first front tractive elements 140a and the second front tractive elements 140b, adjacent to the electric motor, etc.

In some implementations, the cable 316 can be electrically coupled to a respective battery pack 205. The respective battery packs 50 may be located between a first rear tractive element 142a and a second front tractive element 142b, proximate to the respective tractive element 142a, 142b. In some embodiments, the cable 316 may be electrically coupled to a main battery pack, where the main battery pack is operably coupled to secondary battery packs. According to an exemplary embodiment, the front portion 120 may include a first battery pack 205a and the rear portion 130 may include a second battery pack 205b and a third battery pack 205c.

Referring still to FIG. 1, the front portion 120 and the rear portion 130 of the vehicle 100 may include one or more respective busbar connector assemblies 300, such as a first and second busbar connector assemblies at the front portion 120, and a third and fourth busbar connector assemblies at the rear portion 130. The first busbar connector assembly and the second busbar connector assembly may be electrically coupled to the first battery pack 205a and the second battery pack 205b, respectively, as shown in conjunction with FIG. 2. The third busbar connector assembly and the fourth busbar connector assembly may be electrically coupled to the third battery pack 205c and the fourth battery pack 205d, respectively, as shown in conjunction with FIG. 2.

The chassis may further be coupled to a suspension system. The suspension system may comprise four individual suspension assemblies, where each suspension assembly is coupled to the respective tractive element 140, 142. The individual suspension assemblies may comprise at least one of a spring, a shock absorber, a strut, an arm, and a joint. The suspension system may be configured to absorb shock or impact force introduced to the vehicle 100 through the tractive elements 140, 142.

### Vehicle Control System

Referring now to FIG. 2, a schematic of an electrical system 200 of the vehicle 100 is shown. The electrical system 200 may include a battery 205. The battery 205 may be configured to send and receive power, current, voltage, or the like. The battery 205 is connected with a power distribution unit 210 (e.g., battery pack, power source, etc.) configured to distribute power to component(s) of the vehicle 100, such as the electric motors (e.g., motor 504) or electronic devices embedded in the vehicle 100. The power distribution unit (distributor) 210 can be composed of hardware, software, or a combination of hardware and software components. The power distribution unit 210 can include a controller (e.g., electronic control unit (ECU)) configured to provide instructions to control the distribution of power to component(s) of the vehicle 100. The instructions from the controller can be based on various parameters related to the vehicle 100 (e.g., battery capacity, vehicle velocity, battery temperature, motor temperature, vehicle performance mode, etc.) or signals from an operator (e.g., depressing or releasing of an acceleration pedal, etc.).

The power distribution unit 210 may be electrically coupled to a charge port 220. The charge port 220 may be positioned between the power distribution unit 210 and an on-board battery charger module 230 (OBCM), where the charge port 220 electrically couples the power distribution unit 210 to the on-board battery charger module 230. In some cases, the charge port 220 may be positioned at different locations of the vehicle 100, such as the side, rear, front, etc.

The electrical system 200 further includes a secondary battery 240 positioned proximate the front tractive assemblies 140. The secondary battery 240 may be configured to supply power to an auxiliary power module 245 (APM).

Referring still to FIG. 2, the battery 205 may be electrically coupled to a plurality of inverters, shown as first inverter 250a, second inverter 250b, third inverter 250c, and fourth inverter 250d. The plurality of inverters 250a, 250b, 250c, 250d may be configured to convert DC current from the battery 205 into an alternating current voltage (AC current), where the AC current is supplied to the front tractive assemblies 140 and the rear tractive assemblies 142. By way of example, the first inverter 250a is electrically coupled to the first front tractive element 140a, the second inverter 250b is electrically coupled to the second front tractive element 140b, the third inverter 250c is electrically coupled to the first rear tractive element 142a, and the fourth inverter 250d is electrically coupled to the second rear tractive element 142b.

The electrical system 200 may further include a compressor 260. The compressor 260 may be electrically coupled to the battery 205, where the battery 205 delivers a current to the compressor 260. In some embodiments, the compressor 260 may receive current directly from the charge port 220.

The electrical system 200 may further include a layered heater, shown as heater 270. The heater 270 may be electrically coupled to the battery 205, where the battery 205 delivers current to the heater 270.

### Single Busbar Connector Assembly

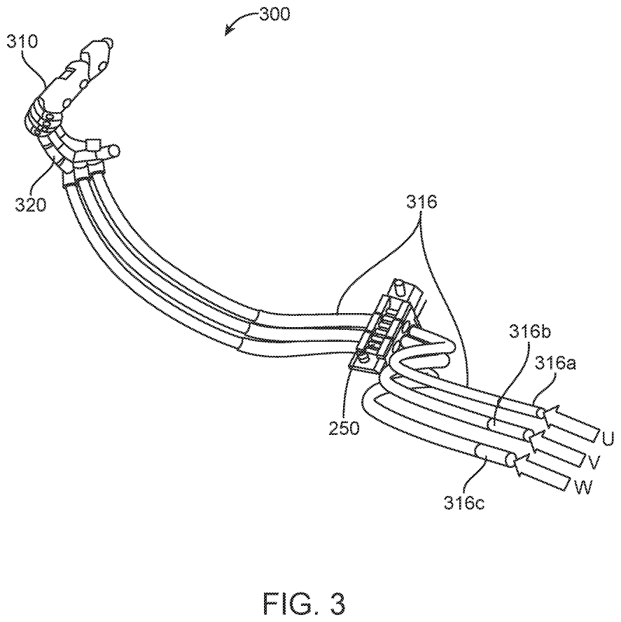

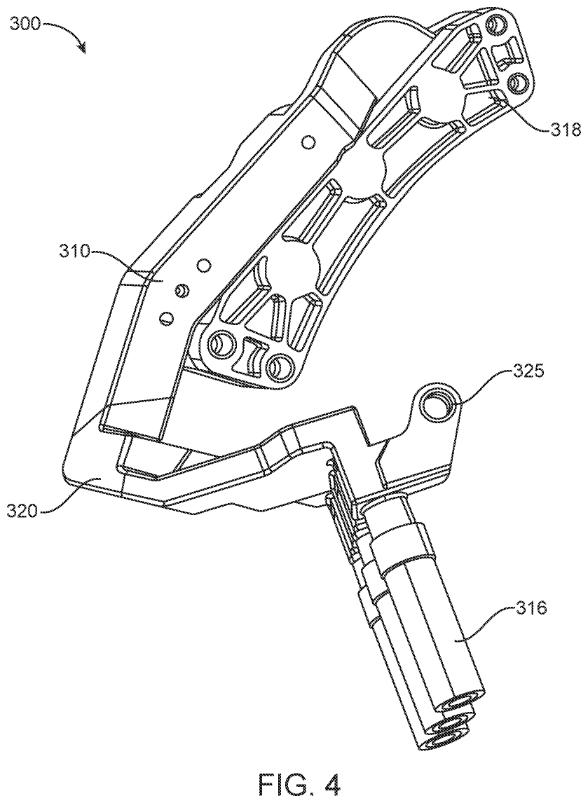

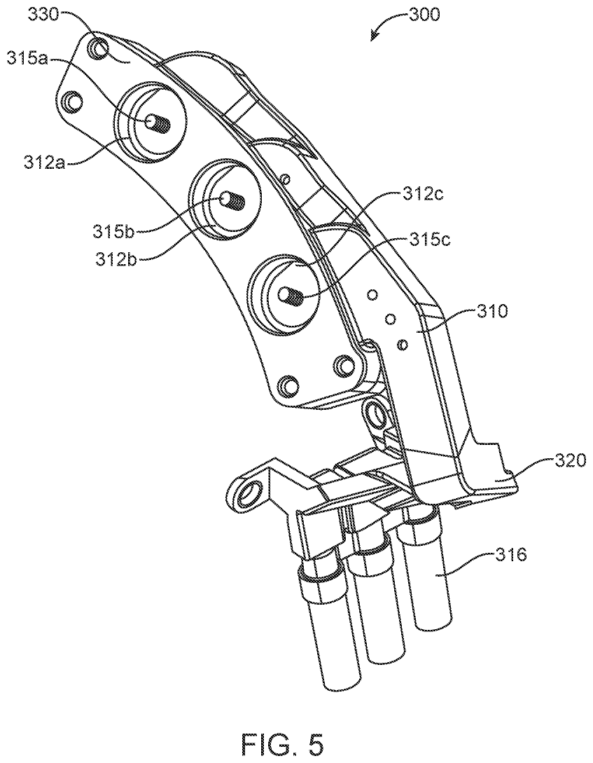

Referring now to FIGS. 3-5, depicted are perspective views of a busbar connector assembly in the electrical system of FIG. 1. FIG. 4 shows a perspective view of a front of the busbar connector assembly 300, and FIG. 5 shows a perspective view of a rear of the busbar connector assembly 300. The busbar connector assembly 300 can include at least one busbar 310. The busbar 310 can be covered with an overmolded portion. A high voltage isolation covering 318 may be provided to at least partially cover the busbar 310. The busbar 310 can include a first side and a second side, where the first side is positioned opposite the second side. By way of example, the first side is an inward face of the busbar 310 and the second side is a rearward face of the busbar 310.

The overmolded portion of the busbar 310 is a continuous portion that surrounds at least a portion of the busbar. The overmolded portion may be coated with conductive paint configured to reduce electromagnetic interference (EMI). To form the overmolded portion, according to an exemplary embodiment, the busbar 310 may be placed into a mold, where plastic is injected into the mold to form the covering 318. In such an embodiment, the plastic covering defines a geometry substantially different from the busbar 310. For example, the overmolded covering may be a non-conformal coating that protrudes by a given distance from the busbar and/or differs in orientation and shape. In some embodiments, the plastic covering defines a geometry substantially similar to the busbar 310, so as to conform to the contours of the busbar 310.

As noted above, the covering 318 is a high voltage isolation cover, and in some embodiments, the covering 318 is coupled to the second side. The covering 318 may include rib structures for increased structural rigidity. In some embodiments, the covering 318 may define a structure for increased cooling within and/or outside of the busbar 310. The covering 318 may be an insulator configured to prevent exposure of the high voltage within the busbar 310 to other components proximate the busbar connector assembly 300.

According to an exemplary embodiment, the covering 318 may be coated with a conductive coating for shielding the busbar 310 from other components of the vehicle 100. The conductive coating may be ultrasonically welded to the busbar 310. In such an embodiment, a spring coil ring is used to attach an outer shield to the conductive coating. In some embodiments, the covering 318 may include an environment shield (e.g., a clamshell, etc.) configured to abut the busbar 310. The environmental shield may provide environmental protection and strain relief to the busbar connector assembly 300.

The busbar 310 includes a first connection region 312a, a second connection region 312b, and a third connection region 312c. The one or more connection regions 312a, 312b, and 312c are longitudinally aligned along a contact plane of the busbar 310. In some embodiments, the one or more connection regions 312a, 312b, 312c are not aligned along the same contact plane. The busbar 310 includes one or more connection points, shown as first connection point 315a, second connection point 315b, and third connection point 315c, positioned within the one or more connection regions. By way of example, the number of connection points corresponds to the number of cable 316, where each cable 316 is electrically coupled to a respective connection point 315a, 315b, 315c. The first connection point 315a is disposed within the first connection region 312a; the second connection point 315b is disposed within the second connection region 312b; and the third connection point 315c is disposed within the third connection region 312c.

The busbar 310 is coupled to a frame 320 (e.g., at least a part of the chassis of the vehicle 100), where the frame 320 extends between the busbar 310 and the cable 316. The frame 320 defines an angular bend radius, where the frame 320 is bent to form an inclined portion. The inclined portion may be at an angle of about 90° in some embodiments. In this manner, the frame 320 can allow for 90° routing around suspension and steering components of vehicle 100. In some embodiments, the angle may be between about 75° to about 90°. In some embodiments, the angle may be about 75°, about 80°, about 85°, about 90°, about 95°, about 100°, about 105°, about 110°, about 115°, about 120°, about 125°, about 130°, about 135°, about 140° or about 145°, or between about 80° to about 180°. In some embodiments, the angular bend radius may not be less than about 90°. In still some embodiments, the angular bend radius may not be greater than about 180°.

Referring to FIG. 3, a perspective view of the busbar connector assembly 300 is shown. The cable 316 define a three phase battery connection comprising a U-phase cable 316a, a V-phase cable 316b, and a W-phase cable 316c which may be respectively connected to the connection regions 312a-c.

Referring still to FIG. 3, the busbar connector assembly 300 is shown coupled to the one or more inverters 250a, 250b, 250c, 250d (e.g., referred to as inverter 250 in FIG. 3). For simplicity, the busbar connector assembly 300 can be connected to the inverter 250. Similarly, other busbar connector assemblies can be connected to the respective inverters 250. The inverter 250 can be electrically coupled to a respective electric motor. In some embodiments, the inverter 250 may be electrically coupled to multiple electric motors. In some other embodiments, multiple busbar connector assemblies 300 may be coupled to a single inverter 250.

According to an exemplary embodiment, the cable 316 electrically coupled to the electric motor (e.g., motor 504) and the inverter 250 may be configured in a suitable circuit arrangement. In this electric motor and the inverter 250, the U-phase cable 316a may be electrically coupled to a first circuit; the V-phase cable 316b may be electrically coupled to a second circuit; and the W-phase cable may be electrically coupled to a third circuit. In other embodiments, the cable 316 electrically coupled to the electric motor and the inverter 250 may be electrically coupled to any circuit arrangement. Additionally, the U-phase cable 316a from the electric motor can be electrically coupled to a first portion of the inverter 250, the V-phase cable 316b from the electric motor can be electrically coupled to a second portion of the inverter 250, and the W-phase cable 316c from the electric motor can be electrically coupled to a third portion of the inverter 250. Other electric motors and/or inverters 250 of the vehicle 100 can be structured or arranged in similar manners.

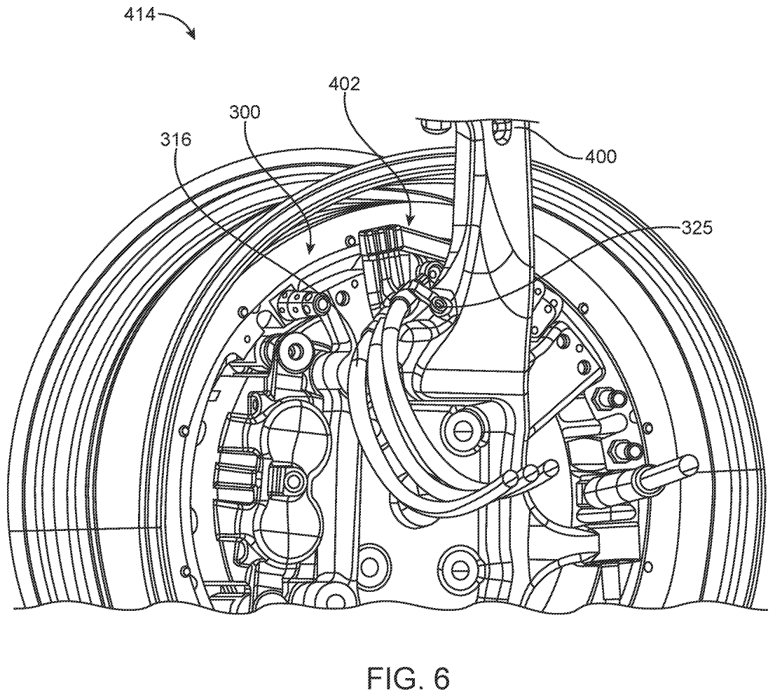

As shown in FIGS. 4 and 5, the frame 320 can include one or more mounting structures (mounts), shown as mounting features 325. Such features can be integrated with frame 320. The mounting features 325 may be one or more arms extending away or in opposite direction from the frame 320. As shown in FIGS. 4 and 5, the one or more arms of the mounting features 325 can be extended in any directions, such as laterally, longitudinally, or vertically according to the design of the vehicle 100. The one or more arms can include a through-hole positioned at the end of the one or more arms. By way of example, the through-holes may be configured to receive a fastener therethrough. The fastener may be coupled to a knuckle (e.g., knuckle 400 in FIG. 6) where the busbar connector assembly 300 may be held structurally rigid to the knuckle. For example, the fastener can be at least one of screws, nails, bolts, anchors, rivets, etc., to secure the busbar connector assembly 300 to the knuckle 400, among other portions of the chassis of the vehicle 100. In some embodiments, the busbar connector assembly 300 can be secure to the knuckle 400 using other suitable types of coupling, locking, or binding mechanisms.

As shown in FIG. 5, the busbar 310 can include a gasket, seal, or insulator, shown as gasket 330. The gasket 330 can be coupled to the first side of the busbar 310. According to an exemplary embodiment, the gasket 330 is an electromagnetic interference (EMI) gasket, where the gasket 330 is configured for environmental and EMI protection. The gasket 330 includes one or more through-holes that correspond with the one or more connection points 315a, 315b, 315c. That is, the one or more through-holes are dimensionally aligned with the one or more connection points 315a, 315b, 315c.

Referring now to FIG. 6, the busbar connector assembly 300 is shown coupled to a knuckle 400. As shown, the busbar connector assembly 300 is fixedly coupled to the knuckle 400 by the fasteners disposed through the mounting features 325. The cable 316 are configured to be routed around (e.g., routed away from, extend away from, etc.) the suspension system 402 and/or the chassis. That is, the cable 316 may be a rigid material with a geometry where the cable 316 are distal from and not substantially proximate the suspension system 402 and/or the chassis. The rigid material of the cable 316 can be configured to insulate or isolate the cable 316 from one another. By way of example, the cable 316 may maintain at least a predetermined clearance or more from the suspension system 402 and/or the chassis. The predetermined clearance may be, for example, a clearance of about 5 mm, about 10 mm, about 15 mm, about 20 mm, about 25 mm, or about 30 mm, etc. from the suspension system 402 and/or the chassis. In some embodiments, the clearance may be between about 5 mm to about 50 mm or between about 5 mm to about 150 mm. As can be appreciated, if the cable 316 are positioned too close to the suspension system 402 and/or the chassis, the cable 316 may become damaged, twisted, cut, bent, or the like. The cable 316 be defined as having a minimum bend radius based on the diameter of the cable 316. By way of example, the minimum bend radius can be found using the following formula:

Minimum Bend Radius=Cable Outer Diameter*Cable Multiplier

The cable multiplier may be based on industry standards that vary depending on the type of cable. The cable type may be determined between at least one of (a) the presence of shielding and (b) the quantity of conductor cables.

### Multiple Busbar Connector Assembly

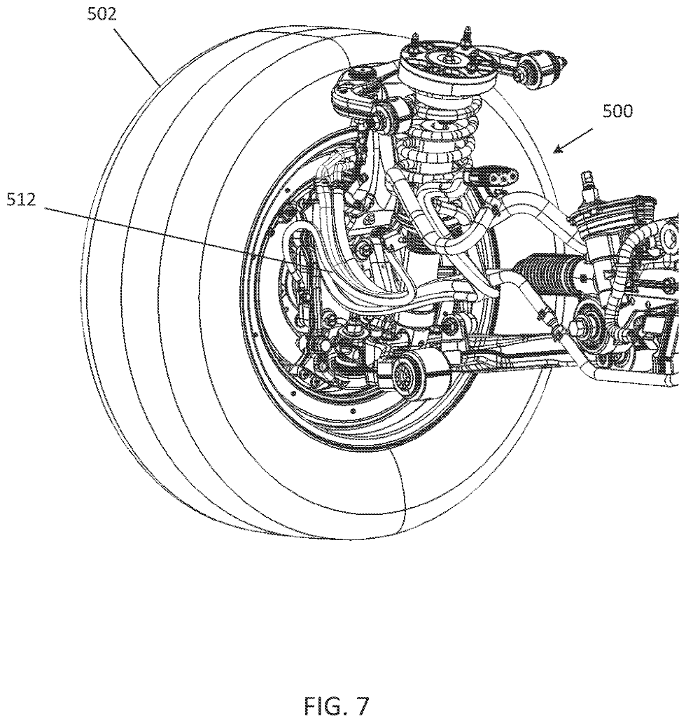

Referring generally to FIGS. 7-26, various views of a busbar connector assembly 500 are shown, according to an exemplary embodiment. The busbar connector assembly 500 may be substantially similar to the busbar connector assembly 300, and, as such, like components may be used to describe the busbar connector assembly 500. The busbar connector assembly 500 may be operably coupled to the electrical system 200 in FIG. 2. Additionally or alternatively, the busbar connector assembly 500 may be operably coupled to an electrical system or control system that is different from that of the electrical system 200. The busbar connector assembly 500 can include additional or alternative components or features relative to the busbar connector assembly 300, for example. It should be understood that the busbar connector assembly 300, 500 may further include additional or alternative features as desired or suitable for the implementation on different vehicles 100.

Referring now to FIGS. 7 and 8, the busbar connector assembly 500 is coupled to a tractive element, e.g., wheel 502 or motor coupled to the wheel 502, where the busbar connector assembly 500 is configured to provide current to a brake system of the wheel 502. In other embodiments, the vehicle 100 may include any number of busbar connector assemblies 500, where the number of busbar connector assemblies 500 are equivalent to a number of wheels 502. As will be discussed in greater detail herein, the busbar connector assembly 500 includes a busbar coupled to the wheel 502. The busbar 545 may be coupled to a first end of the busbar connector assembly 500.

The busbar 545 may be covered by an overmolded portion. A high voltage insulation covering, referred to herein as covering, may further be provided to at least partially cover the busbar 545. Although not shown, the busbar 545 includes a first side and a second side, where the first side is positioned opposite the second side. By way of example, the first side is an inward face of the busbar 545 and the second side is a rearward face of the busbar 545.

The overmolded portion of the busbar 545 is a continuous portion that surrounds at least a portion of the busbar. The overmolded portion may be coated with conductive paint configured to reduce or otherwise provide protection against electromagnetic interference (EMI). As with the busbar 310, to form the overmolded portion, according to an exemplary embodiment, the busbar 545 may be placed into a mold, where plastic is injected into the mold to form the covering. In such an embodiment, the plastic covering defines a geometry substantially different from the busbar 545. For example, the overmolded covering may be a non-conformal coating that protrudes by a given distance from the busbar and/or differs in orientation and shape. In some embodiments, the plastic covering can represent or define a geometry substantially similar to the busbar 545, so as to conform to the contours of the busbar 545.

As described herein, the covering can be a high voltage isolation cover. In some embodiments, the covering can be coupled to the second side of the busbar 545 (e.g., a second side surface of the busbar 545). The covering may include rib structures for increased structural rigidity. In some embodiments, the covering may define a structure for increased cooling within and/or outside of the busbar 545. The covering may be an insulator configured to prevent exposure of the high voltage within the busbar 545 to other components proximate to the busbar connector assembly 500.

According to an exemplary embodiment, the covering may be coated with a conductive coating for shielding the busbar 545 from other components of the vehicle 100. The conductive coating may be ultrasonically welded to the busbar 545. In such an embodiment, a spring coil ring is used to attach an outer shield to the conductive coating. In some embodiments, the covering may include an environment shield (e.g., a clamshell, etc.) configured to abut the busbar 545. The environmental shield may provide environmental protection, shock absorption and strain relief to the busbar connector assembly 500.

The busbar connector assembly 500 can include cable 512 (e.g., wiring) coupled to both the busbar 545 and an inverter (e.g., inverter 250 as described in conjunction with FIG. 2). The cable 512 may be configured to or capable of transferring (e.g., supplying or distributing) current or power from the inverter to the busbar 545. The cable 512 can define a three-phase battery connection including, for instance, a U-phase cable 512a, a V-phase cable 512b, and a W-phase cable 512c. For example, the vehicle 100 may include one or more sets of cable 512 configured for respective three-phase battery connections. Further, the cable 512 can be configured for connecting the three-phase battery connections to a three-phase motor (e.g., an electric motor). According to an exemplary embodiment, the inverter may be configured in a circuit arrangement. In such an embodiment, the inverter and the U-phase cable 512a may be electrically coupled to a first circuit, the V-phase cable 512b may be electrically coupled to a second circuit, and the W-phase cable 512c may be electrically coupled to a third circuit. In other embodiments, the inverter may be electrically coupled to any circuit arrangement. Additionally, the U-phase cable 512a is electrically coupled to a first portion of the inverter, the V-phase cable 512b is electrically coupled to a second portion of the inverter, and the W-phase cable 512c is electrically coupled to a third portion of the inverter.

By way of example, the circuit arrangement discussed above may be applied to any number of the one or more sets of cable 512. The number of circuit arrangements may be equivalent to a number of the sets of cable 512. As can be appreciated, the vehicle includes four sets of cable 512 electrically coupled to four circuit arrangements. In such an embodiment, the four circuit arrangements may be substantially similar to one another and be configured to provide a substantially similar amount of power to the individual circuit arrangements.

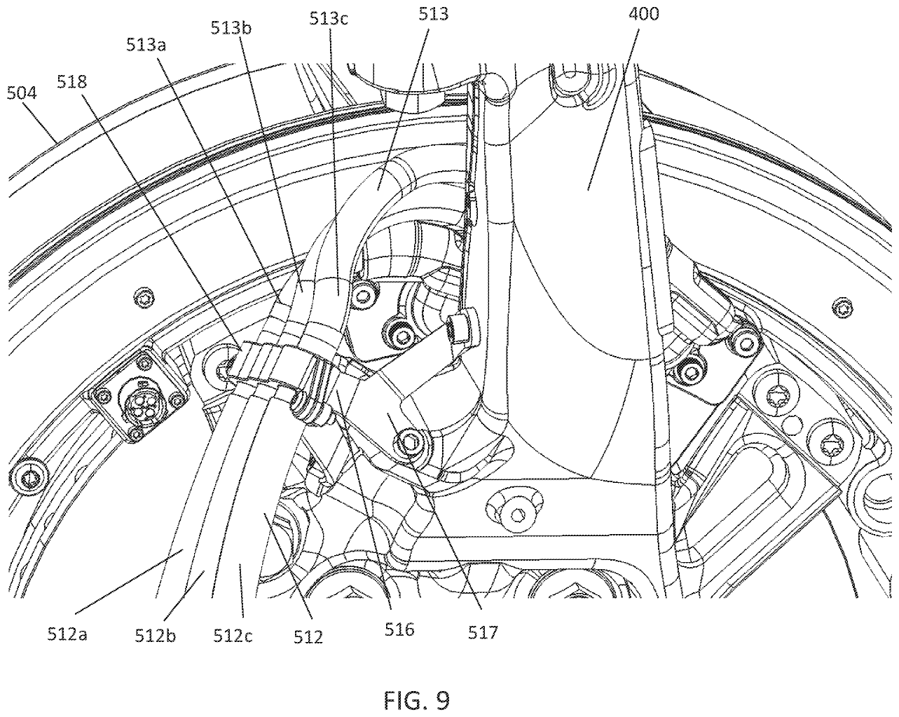

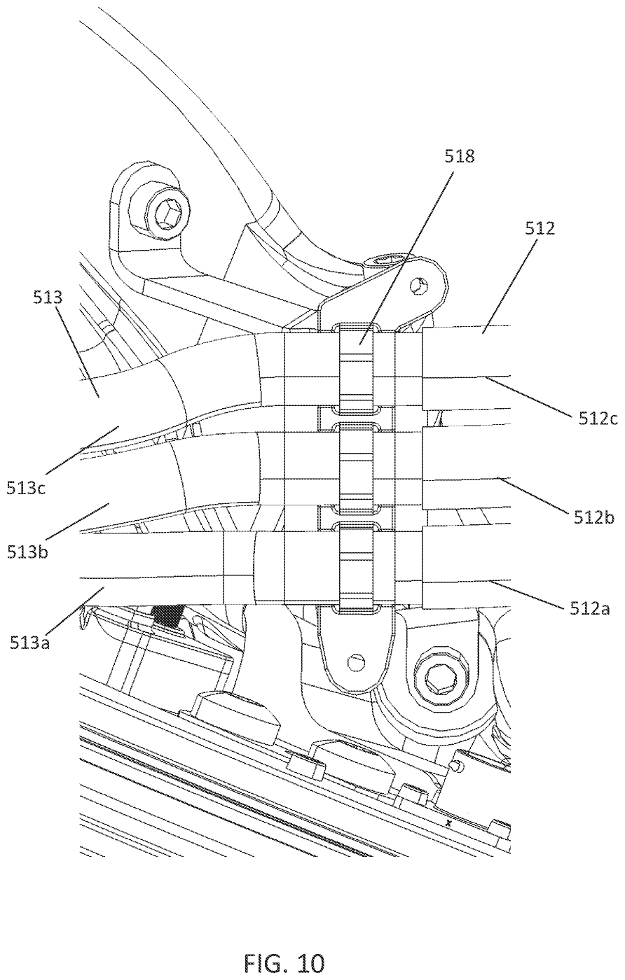

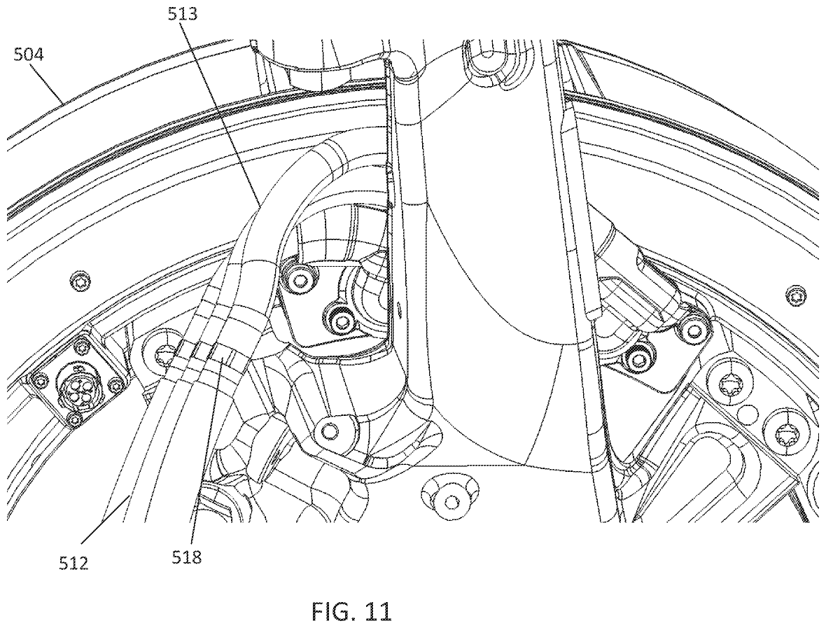

Referring to FIGS. 9 and 10, depicted are perspective views of a bracket and one or more crimps 518 used on the bracket. Further, FIG. 11 depicts a perspective view of the one or more crimps 518 without the bracket. The cable 512 can include one or more wiring connections 513. The wiring connections 513 may be coupled to both the cable 512 and the busbar 545. According to an exemplary embodiment, the wiring connections 513 may be coupled to the busbar 545 via a bracket (e.g., upper hold bracket 516 and lower hold bracket 517). In such an embodiment, the bracket may receive a fastener therethrough. In some embodiments, the wiring connections 513 may be hollow connections configured to form over a protrusion on the busbar 545. In other embodiments, the wiring connections 513 may be male connections configured to be inserted into a receiving portion on the busbar 545. In still other embodiments, the wiring connections 513 could be quick connect/disconnect connections configured to be coupled to the busbar 545. The wiring connections 513 may include a U-phase connection 513a, V-phase connection 513b, and W-phase connection 513c. By way of example, the U-phase connection 513a may be coupled to the U-phase cable 512a; the V-phase connection 513b may be coupled to the V-phase cable 512b; and the W-phase connection 513c may be coupled to the W-phase cable 512c. The wiring connections 513a-513c may be substantially oriented substantially different to one another in relation to the busbar 545. In other embodiments, the wiring connection 513a-513c may be oriented substantially similar to one another in relation to the busbar 545.

The busbar connector assembly 500 may include one or more brackets, such as an upper hold bracket 516 and a lower hold bracket 517. Additionally or alternatively, the upper hold bracket 516 and the lower hold bracket 517 may be a unitary bracket (e.g., parts of the same bracket). In some other cases, the upper hold bracket 516 and the lower hold bracket 517 may separate brackets. The upper hold bracket 516 may be configured to secure the cable 512 angularly relative to the busbar 545. Further, the upper hold bracket 516 may be configured to secure the cable 512 in place so that the cable 512 is accessible when the wheel is in a plurality of positions. For example, the upper hold bracket 516 holds the cable 512 in place so that turning of the wheel between a left and right positions does not release the cable 512 from engagement with the busbar 545. As can be appreciated, the cable 512 between the upper hold bracket 516 and the busbar 545 changes position and orientation when the wheel turns between the left and right positions. The upper hold bracket 516 may be also be configured to secure the cable 512 to the lower hold bracket 517.

The lower hold bracket 517 may be configured to secure the cable 512 angularly relative to the busbar 545. Further, the lower hold bracket 517 may be configured to secure the cable 512 in place so that the cable 512 is accessible when the wheel is in the plurality of positions. For example, the lower hold bracket 517 holds the cable 512 in place so that turning of the wheel between the left and right positions does not release the cable 512 from engagement with the busbar 545. The lower hold bracket 517 may also be configured to secure the cable 512 to the upper hold bracket 516. As can be appreciated, the upper hold bracket 516 and the lower hold bracket 517 may be cooperatively configured to orient and secure the cable 512.

The upper hold bracket 516 may include one or more securement apparatuses, crimps, etc., shown as crimps 518. The crimps 518 may be configured to receive at least a portion of the cable 512. In other embodiments, the crimps 518 may be configured to wholly receive the cable 512. The crimps 518 may provide a primary axial load damage prevention point for the cable 512 by reacting against the upper hold bracket 516. For example, the crimps 518 may absorb and deflect axial loads induced onto the crimps 518 to prevent the axial load from damaging the cable 512. By way of example, the upper hold bracket 516 includes three crimps 518, where each crimp 518 is coupled to a wire (e.g., U-phase cable 512a, V-phase cable 512b, and W-phase cable 512c). As can be appreciated, the upper hold bracket 516 may include an equivalent amount of crimps 518 and wires. In other embodiments, the upper hold bracket 516 may include a pre-determined number of crimps 518, where individual wires are provided based on system needs (e.g., more power, additional system, etc.).

In some embodiments, the bracket (e.g., upper hold bracket 516 and/or lower hold bracket 517) may be configured to isolate at least a portion of the cable 512 from other elements components within the chassis of the vehicle 100. For example, the upper hold bracket 516 or the lower hold bracket 517 can fasten or fix the cable 512 at the desired position and/or angle within the chassis. In some embodiments, the position may be a predetermined position and the angle may be a predetermined angle to achieve clearance in the x-, y- and z-directions from another object. Thus, the cable 512 can be arranged to have a clearance from another object within a chassis of the vehicle. The predetermined position may be a height, for example, between the cable 512 and a surface of one of the upper or lower hold brackets 516, 517. In some embodiments, the bracket can be configured to mount the cable 512 to the knuckle 400 of the chassis to position the cable 512 at a fixed angle. In other embodiments, the bracket position and/or angle of the cable 512 may be adjustable. The adjustable positioning and/or angle can minimize contact or friction of the cable 512 from other components. The adjustable positioning can be used to facilitate ease of service or maintenance by allowing the cable 512 to be positioned at a variable angle so as to allow greater ease of access by a service technician, for example.

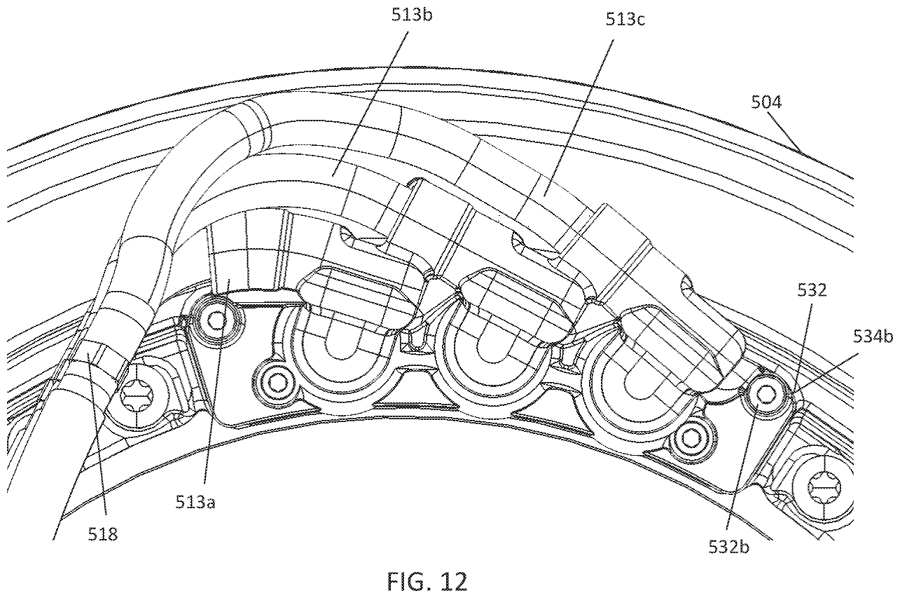

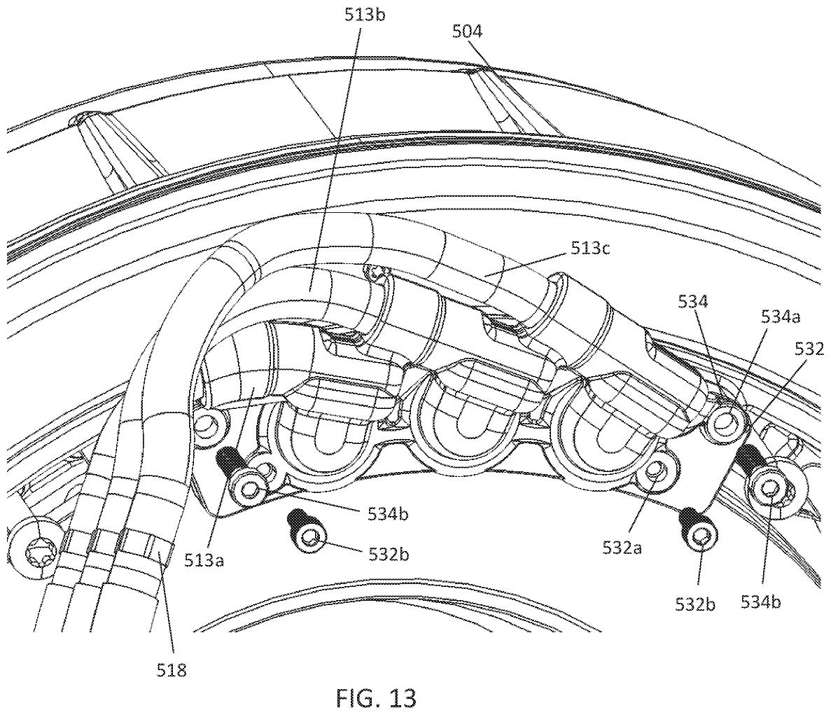

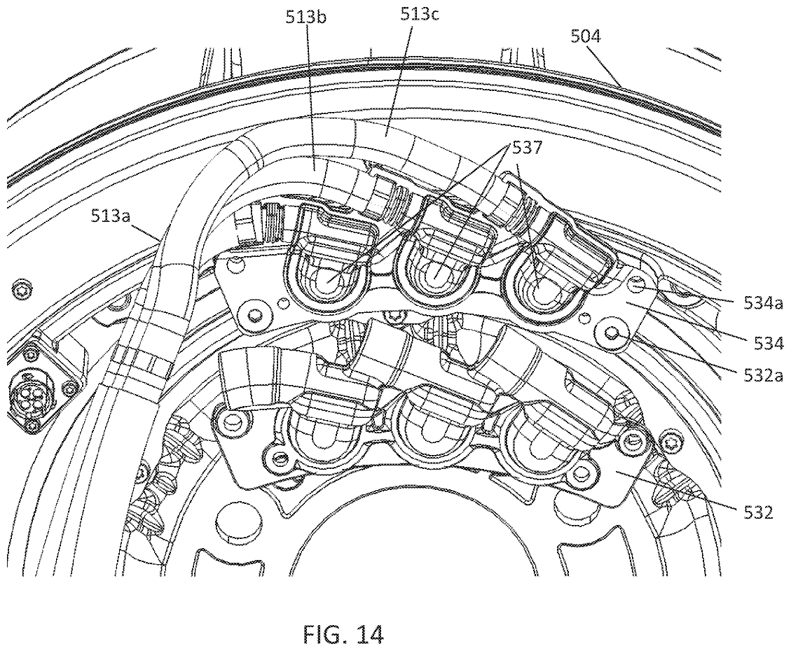

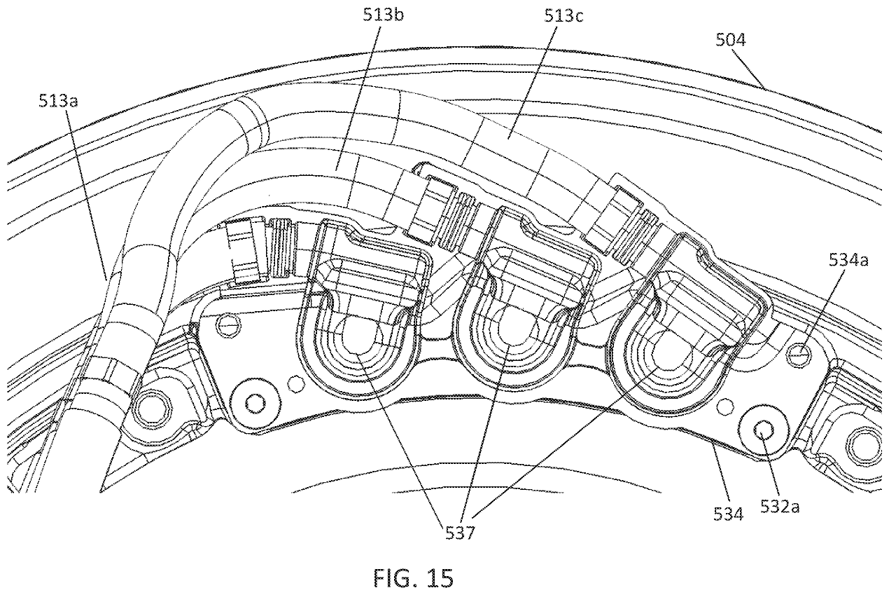

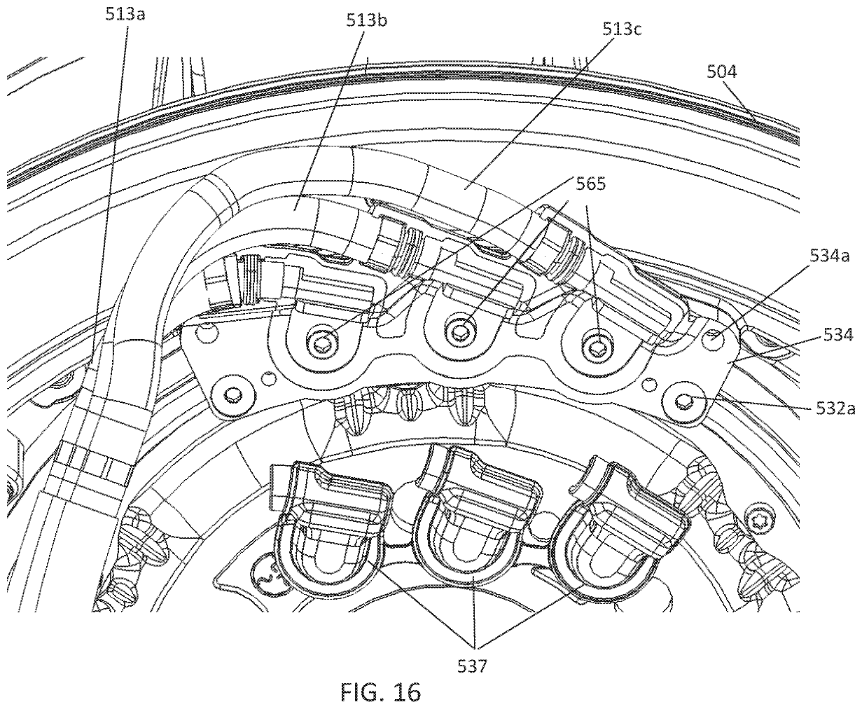

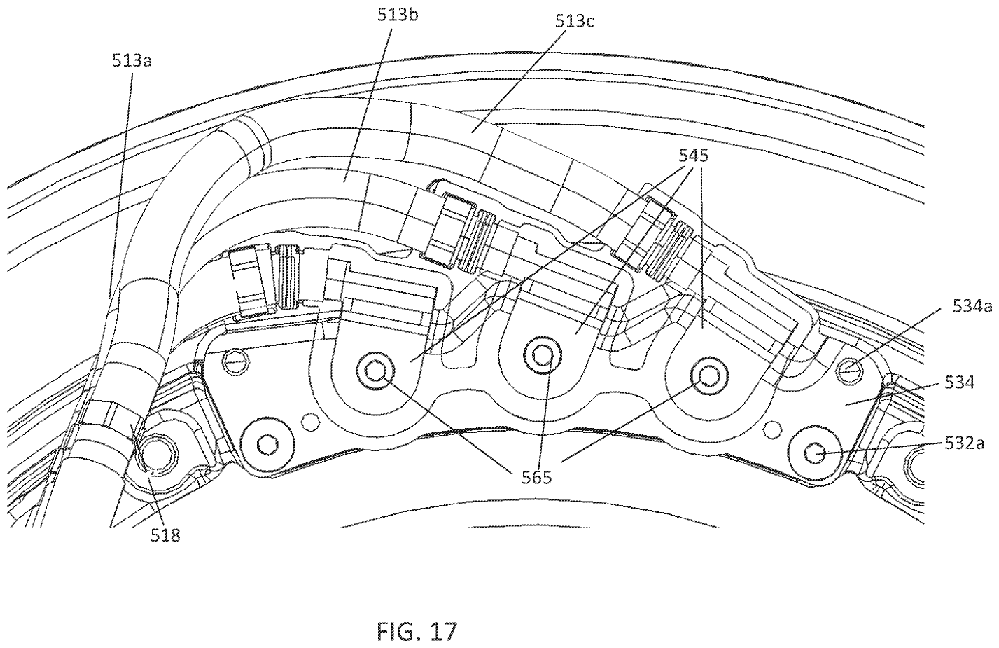

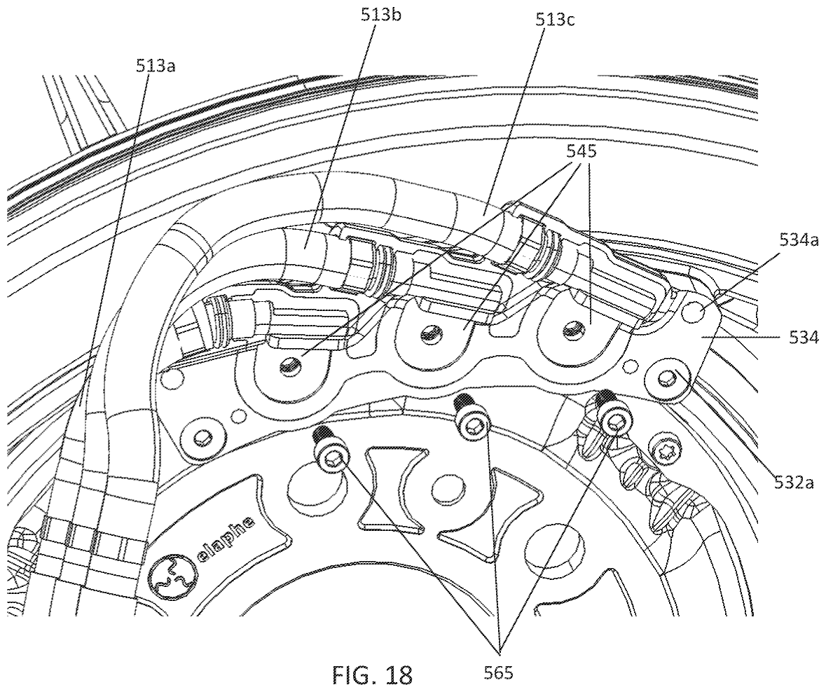

Referring now to FIG. 12-18, depicted are perspective views of a portion of the busbar connector assembly 500. For example, FIG. 12 is a perspective view of an outboard housing 534 of the busbar connector assembly 500. FIG. 13 is a perspective view of fasteners (e.g., 532b and/or 534b) used on the busbar connector assembly 500. FIG. 14 is a perspective view of the outboard housing 534 separated from the inboard housing 532 of the busbar connector assembly 500. FIG. 15 is a perspective view of the inboard housing 532 of the busbar connector assembly 500. FIG. 16 is a perspective view of inboard seals 537 separated from the outboard housing of the busbar connector assembly 500. FIG. 17 is a perspective view of busbars 545 of the busbar connector assembly 500. FIG. 18 is a perspective view of fasteners 565 used on the busbars 545 of the busbar connector assembly 500.

The busbar connector assembly 500 can include an inboard housing 532 (e.g., sometimes referred to as outer housing) and an outboard housing 534 (e.g., sometimes referred to as inner housing). The inboard housing 532 may be positioned inward the wheel 502 or the motor 504, distal (e.g., relatively farther from) a central portion of the vehicle 100. The outboard housing 534 may be positioned outward the inboard housing 532, proximate (e.g., relatively closer to) the central portion of the vehicle 100. The outboard housing 534 may be positioned over at least a portion of the inboard housing 532. In other embodiments, the outboard housing 534 may be wholly positioned over the inboard housing 532. In some implementations, the outboard housing 534 may be coupled to the motor 504 (e.g., in contact or proximate to the motor 504), where the inboard housing 532 can be coupled to the outboard housing 534 relatively distal from the motor 504 (e.g. motor connection port 582).

The inboard housing 532 may include one or more apertures 532a. The one or more apertures 532a may be positioned opposite to one another along the inboard housing 532. The apertures 532a can be strategically positioned or configured to secure components of the busbar connector assembly 500 together, such as at least the outboard housing 534 to the inboard housing 532. For example, the one or more apertures 532a may include two apertures positioned opposite one another along an upper portion of the inboard housing 532. The one or more apertures 532a may be configured to receive one or more fasteners 532b therethrough. The one or more fasteners 532b may be screws (e.g., cap screws, etc.) where the screws are threadably engaged within the one or more apertures 532a. By way of example, the one or more apertures 532a may include a threaded structure disposed along an inner wall of the one or more apertures 532a, where a threaded structure of the one or more fasteners 532b interfaces with the threaded structure of the one or more apertures 532a. In other embodiments, the one or more apertures 532a may include a smooth inner wall such as to allow the one or more apertures 532a to pass therethrough. The one or more fasteners 532b may be configured to secure the inboard housing 532 to a motor disposed between the inboard housing 532 and the wheel. In other embodiments, the one or more fasteners 532b may be configured to secure the inboard housing 532 to the outboard housing 534 via one or more apertures 532a, 534a which are at least partially aligned between the inboard housing 532 and the outboard housing 534.

The outboard housing 534 may include one or more apertures 534a. The one or more apertures 534a may be positioned opposite one another along the outboard housing 534. For example, the one or more apertures 534a may include two apertures positioned opposite one another along a lower portion of the outboard housing 534. As with the apertures 532a, the one or more apertures 534a may be configured to receive one or more fasteners 534b therethrough. The one or more fasteners 534b may be screws (e.g., cap screws, etc.) where the screws are threadably engaged within the one or more apertures 534a. By way of example, the one or more apertures 534a may include a threaded structure disposed along an inner wall of the one or more apertures 534a, where a threaded structure of the one or more fasteners 534b interfaces with the threaded structure of the one or more apertures 534a. In other embodiments, the one or more apertures 534a may include a smooth inner wall such to allow the one or more apertures 534a to pass therethrough. The one or more fasteners 534b may be configured to secure the outboard housing 534 to the inboard housing 532. The one or more apertures 532a may be substantially similar to the one or more apertures 532a such that the one or more apertures 532a, 534a may be configured to receive substantially the same fastener (e.g., one or more fasteners 532b, 534b). The outboard housing 534 may be manufactured out of aluminum. In other embodiments, the outboard housing 534 may be manufactured out of a material other than aluminum (e.g., steel, copper, iron, polymer, carbon, etc.). By way of example, an aluminum inboard housing may be characterized to support in electromagnetic interference (EMI) shielding and structural rigidity.

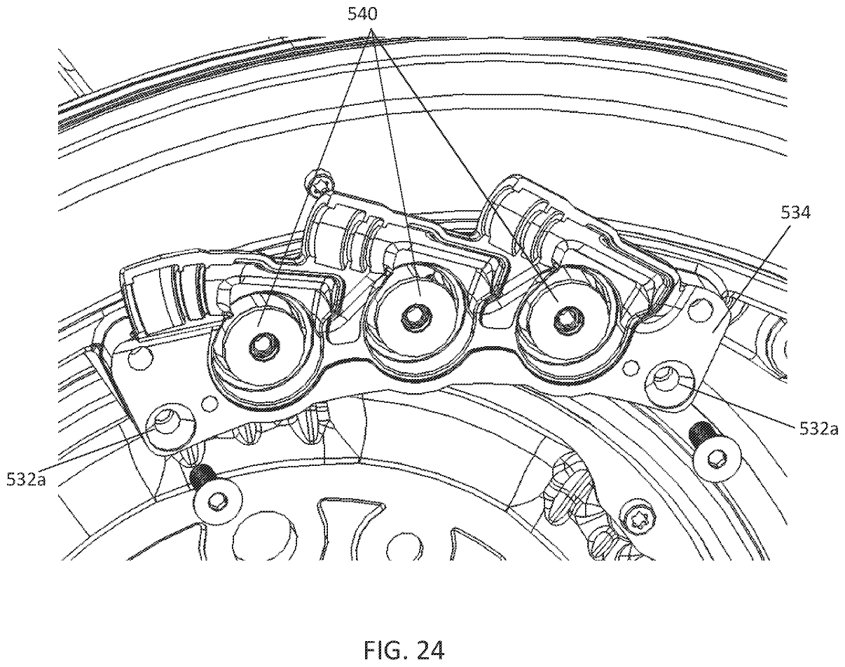

As shown in FIG. 13, the fasteners 532b, 534b can be loosened or removed from the inboard housing 532 and the outboard housing 534. Subsequently, the inboard housing 532 can be separated or decoupled from the outboard housing 534 after removing the fasteners 532b, 534b. After removing the inboard housing 532, the apertures 532a and the inboard seals 537 can be exposed at various positions of the outboard housing 534, as shown in FIG. 15. The apertures 532a can be used to secure the outboard housing 534 to the motor 504 (or the wheel 502) via respective fasteners, as described in conjunction with FIG. 24.

As shown in FIGS. 15-16, the outboard housing 534 may include or be coupled to the inboard seal 537. The inboard seal 537 may be a seal positioned over a portion of the outboard housing 534. According to an exemplary embodiment, the inboard seal 537 may be wholly provided over the outboard housing 534 to provide an airtight seal therebetween. The inboard seal 537 may be coupled to the outboard housing 534 via any suitable coupling mechanisms, such as friction fit, using screws, or other types of fasteners. As can be appreciated, with the inboard seal 537 wholly provided over the outboard housing 534, moisture (e.g., water, etc.) may not enter into the outboard housing 534. The inboard seal 537 may be repositionable between a neutral (normal) state and a compressed state. In the neutral state, the inboard seal 537 may not be assembled into the outboard housing 534 or the inboard seal 537 may not be providing a sealing function. In the compressed state, the inboard seal 537 may be assembled into the outboard housing 534 or the inboard seal 537 may be providing a sealing function. In some embodiments, the inboard seal 537 may provide a level of sealing when the inboard seal 537 is in the neutral state. Although the inboard seal 537 is contemplated as a unitary body, the inboard seal 537 may further be over-molded onto each busbar 545.

FIG. 17 illustrates the busbar connector assembly 500 without the inboard seal 537, thereby exposing the face of the busbar 545. As shown also in at least FIG. 18, the busbar connector assembly 500 can include one or more fasteners, shown as fasteners 565 (e.g., screws in this case). The busbar 545 can include an aperture configured to receive the fasteners 565 for securing the busbar 545 to the outboard housing 534 or the cavity 540. In some embodiments, the fasteners 565 can fasten the busbar 545 to at least one of the motor 504 (e.g., motor connection port 582, described herein) or the outboard housing 534. The cavities 540 and fasteners 565 may be provided as complementary pairs such that there is an equivalent number or substantially similar number of each, in some embodiments.

In some embodiments, the cavity 540 can be a part of the outboard housing 534 configured to couple the busbar 545 with the motor 504 (e.g., motor connection port 582). In some cases, the cavity 540 may represent an opening extending throughout the various components of the bus connector assembly 500 to the motor connection port 582. In some other cases, the cavity 540 can correspond to the motor connection port 582. By way of positioning the busbar 545 in the cavity 540 and coupling the inboard housing 532 to the outboard housing 534, the busbar 545 can be interposed between the housings 532, 534.

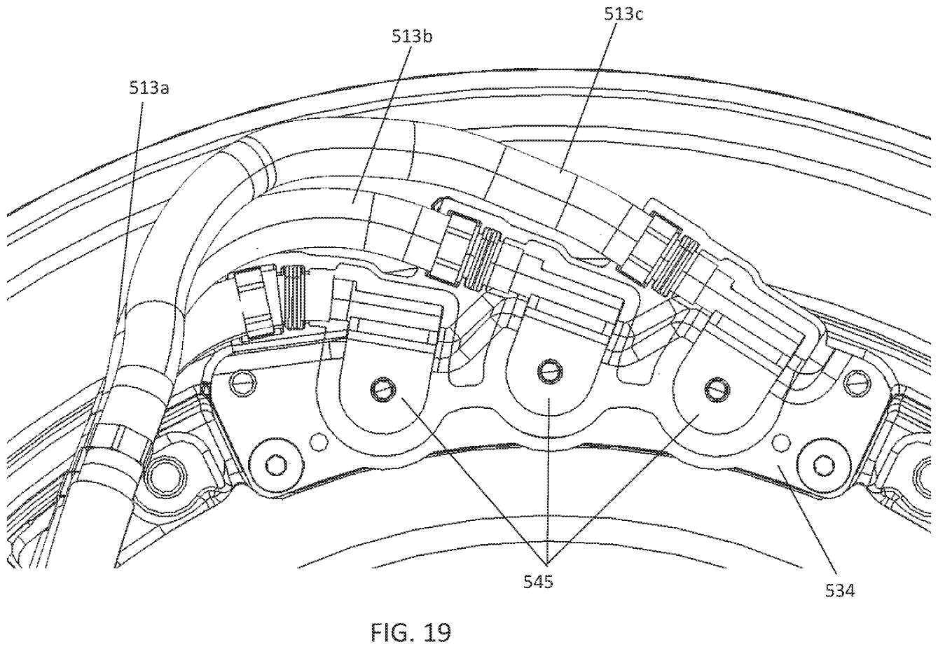

Referring now to FIGS. 19-21, the inboard housing 532 can include the one or more busbars 545 situated or positioned at one or more connection cavities (e.g., cavities 540). The cavities 540 may be conductive cavities configured to receive one or more busbars 545 for electrically coupling the busbar 545 to the motor 504. The cavities 540 may be defined as recessed cavities extending into the outboard housing 534. In other embodiments, the cavities 540 may be protruded outward from the outboard housing 534. As can be appreciated, the outboard housing 534 can include three cavities 540 that are each configured to receive three busbars 545. Alternatively, the inboard housing 532 can include any number of cavities 540 that are each configured to receive any number of busbars 545. By way of illustrative example, three busbars 545 can be provided for coupling with three cavities 540. The three busbars 545 may be a first busbar 545a, a second busbar 545b, and a third busbar 545c. By way of example, the first busbar 545a is operably coupled to the U-phase cable 512a; the second busbar 545b is operably coupled to the V-phase cable 512b; and the third busbar 545c is operably coupled to the W-phase cable 512c.

In some embodiments, the busbars 545 may be coupled to the cable 512 proximate to an end of the cable 512. The busbars 545 may be ultrasonically welded to the cable 512. In other embodiments, the busbars 545 may be coupled to the cable 512 via one or more fasteners (e.g., bracket, nut, bolt, housing, etc.), among other coupling mechanisms. The busbars 545 may be sized substantially similar to the cavities 540 where the busbars 545 are tightly received within the cavities 540. The busbars 545 may be manufactured out of or composed of any type of metallic or conductive materials (e.g., copper, steel, aluminum, brass, alloys, etc.).

The cable 512 may further include one or more conductive o-rings, shown as o-ring 550, positioned proximate to the busbar 545 or the end of the cable 512. The o-ring 550 can be a part of the bus connector assembly 500. The o-ring 550 may be conductive o-rings used for EMI shielding. For instance, the o-rings 550 achieve EMI shielding by being positioned between, or filling, a gap between the cable 512 and the housings 532, 534. The o-rings 550 may be manufactured out of rubber, where the rubber acts as an insulator. The o-rings 550 may be composed of additional or alternative types of insulating material or combinations thereof.

The cable 512 can include one or more secondary crimps 555 (e.g., sometimes referred to as secondary crimps). The crimps 555 may be similar to the crimps 518 (similar features or compositions) discussed in FIGS. 9-13, although the crimps 555 may not be fixedly coupled to the upper hold bracket 516, for example. The crimps 555 can be coupled to at least one portion of the cable 512. In some cases, multiple crimps 555 may be positioned at various locations of the cable 512. For example, the crimps 555 may be coupled to or positioned proximate to the o-ring 550 and opposite the busbar 545. In other embodiments, the crimps 555 may be positioned proximate the busbar 545. The crimps 555 can isolate at least the coupled portion of the cable 512 from direct contact with various components of the vehicle 100 (e.g., the chassis of the vehicle 100) to prevent axial load damage. For instance, the crimps 555 may provide a secondary axial load damage prevention point for the cable 512 by reacting against at least one of the housings 532, 534. For example, the crimps 555 can enhance the structural integrity of the cable 512 by absorbing and/or deflecting axial loads induced onto the crimps 555 to prevent the axial load from damaging the cable 512.

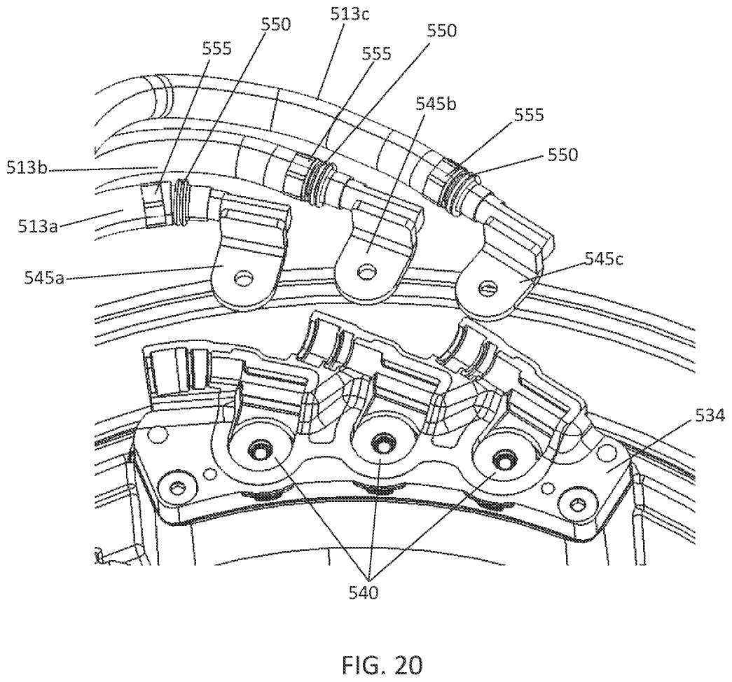

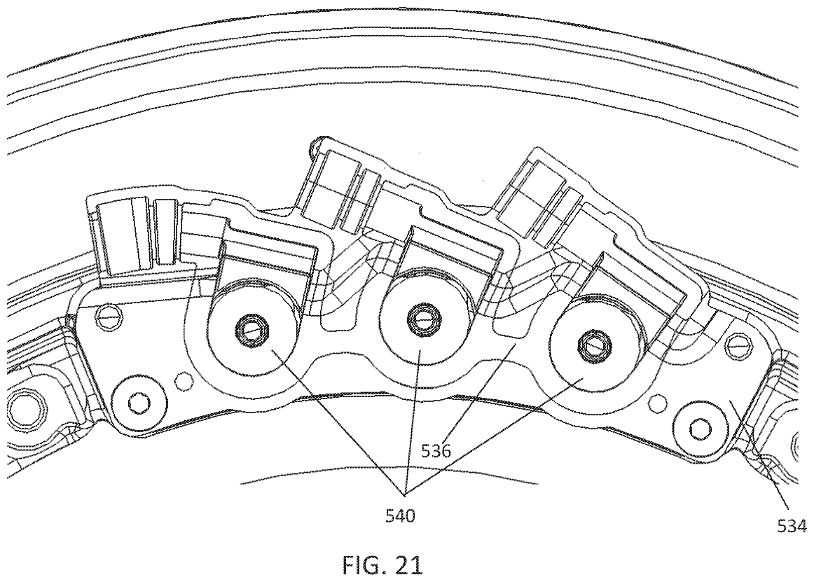

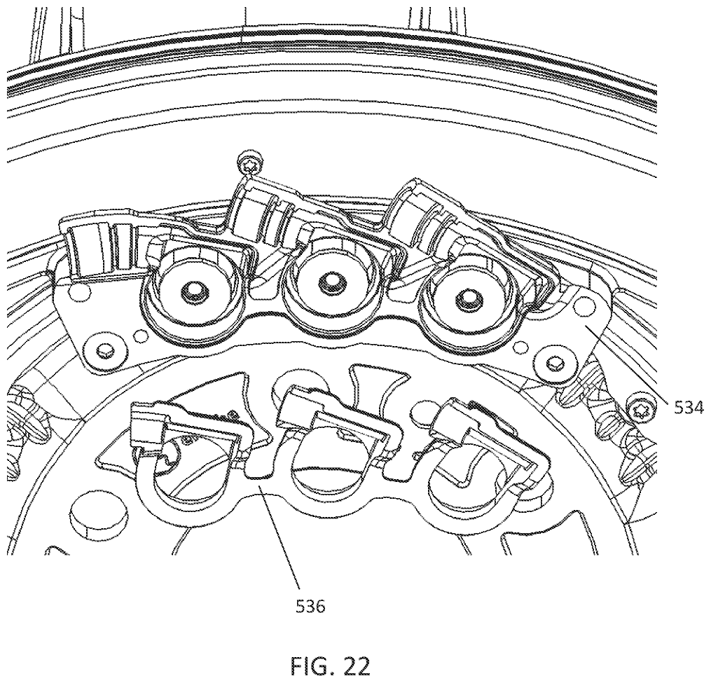

As shown in FIG. 19, the fastener 565 securing or coupling the busbars 545 to the cavities 540 can be detached. Subsequently, referring to FIG. 20, the busbars 545, among other structures interconnected thereof, can be separated or decoupled from the cavities 540. FIG. 21 depicts the cavities 540 and at least one seal (e.g., outboard seal 536) surrounding at least a portion of the cavities 540, as described in further detail in at least FIG. 22. As shown herein, a proximal end of the cable 512 can be positioned laterally from the outboard housing 534 and/or the inboard housing 532 by a perpendicular extension of the busbar 545. In this case, the busbar 545 can be structured or formed at least at 90° angle, among other angles.

Referring now to FIG. 22, the outboard housing 534 can include at least one seal, such as an outboard seal 536 (e.g., sometimes referred to as a first seal). The outboard seal 536 may be a seal positioned over a portion of the outboard housing 534 and/or at least a portion of the cavities 540. According to an exemplary embodiment, the outboard seal 536 may be wholly provided over the outboard housing 534 to provide an airtight seal therebetween. As can be appreciated, with the outboard seal 536 wholly provided over the outboard housing 534, moisture (e.g., water, etc.) may not enter into the outboard housing 534. The outboard seal 536 may be repositionable between a neutral state and a compressed state. In the neutral state, the outboard seal 536 may not be assembled into the outboard housing 534 or the outboard seal 536 may not be providing a sealing function. In the compressed state, the outboard seal 536 may be assembled into the outboard housing 534 or the outboard seal 536 may be providing a sealing function. In some embodiments, the outboard seal 536 may provide a level of sealing when the outboard seal 536 is in the neutral state. Although the outboard seal 536 is contemplated as a unitary body, the outboard seal 536 may further be over-molded onto each busbar 545.

According to an exemplary embodiment, the outboard seal 536 is positioned within or over at least a portion of each cavity 540, before the busbar 545 is positioned within the cavity 540. The outboard seal 536 can include one or more openings (e.g., the number of openings depending on the number of busbars 545 or cavities 540). The openings defined by the outboard seal 536 can be sized similarly to the busbars 545, thereby enabling the busbars 545 to be positioned or situated in the cavities 540. Once the busbar 545 is placed into the cavity 540, the inboard seal 537 (e.g., sometimes referred to as a second seal, described in FIG. 16) may then be positioned over the top of the busbar 545 and/or the outboard seal 536. In some embodiments, when positioning the busbar 545 at the cavity 540, the outboard seal 536 is configured to surround the busbar 545 (e.g., sides). Further, the inboard seal 537 can be coupled to the outboard seal 536 to encapsulate the busbar in between the seals. The combination of the outboard seal 536 and the inboard seal 537 can form an airtight seal around the busbar 545, thereby preventing foreign substances (e.g., moisture) from entering.

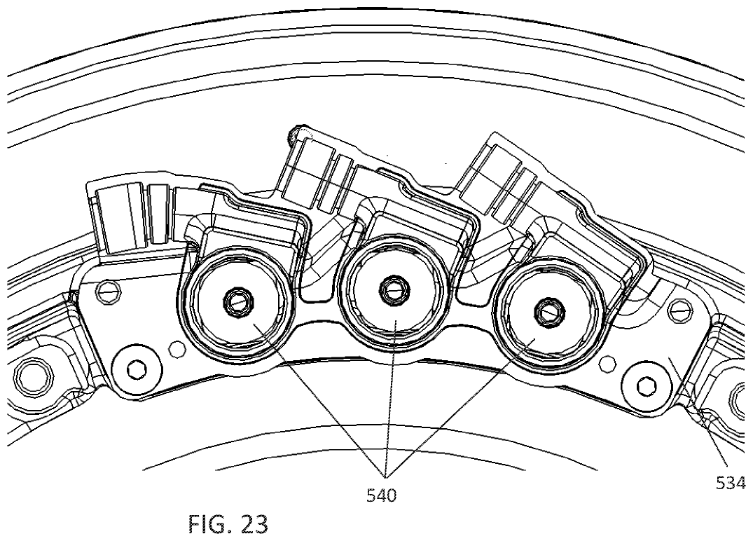

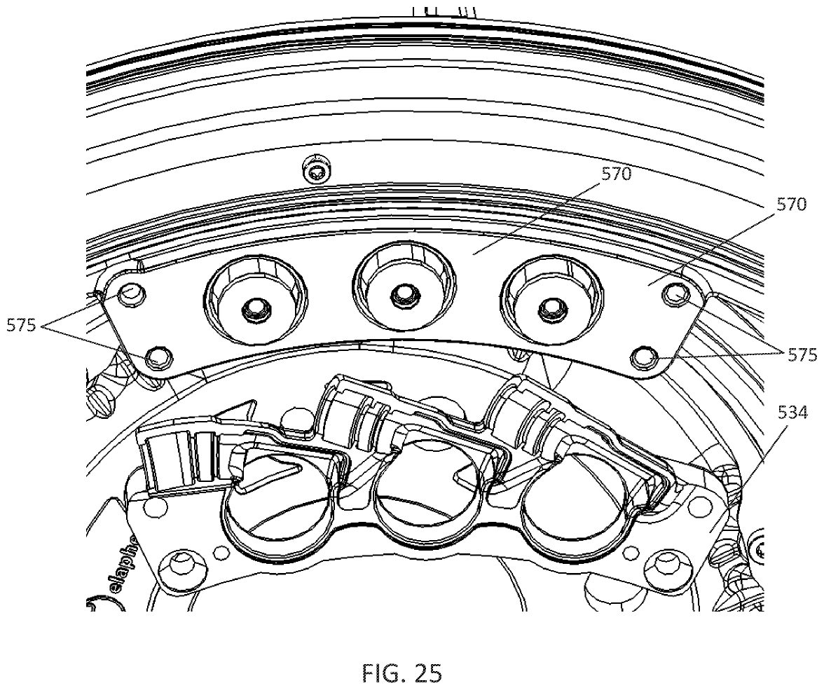

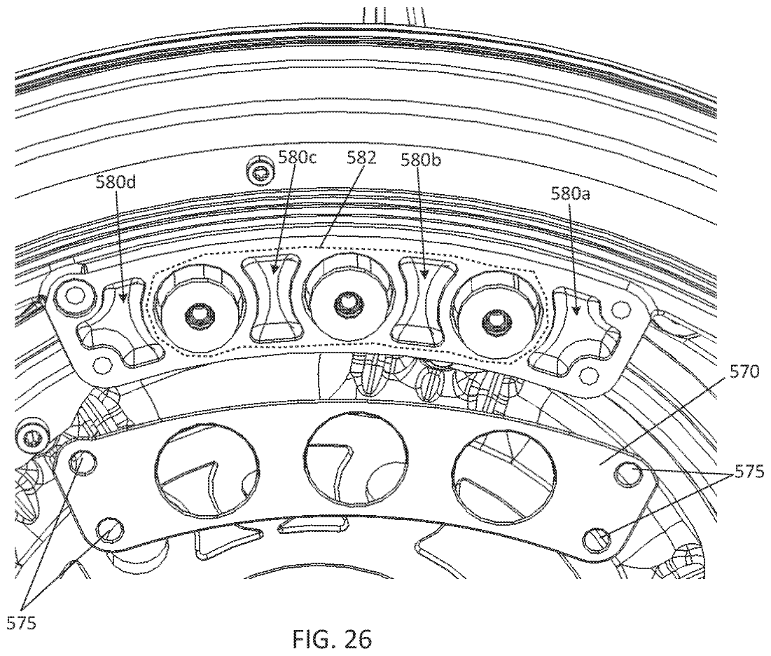

Referring now to FIGS. 23-26, the busbar connector assembly 500 may include a conductive gasket 570 (e.g., electromagnetic interference gasket). The conductive gasket 570 may be positioned between the outboard housing 534 and the inboard housing 532. In some embodiments, the conductive gasket 570 may be positioned between (i) either one of the outboard housing 534 or the inboard housing 532, and (ii) the motor. In this case, as shown in at least FIG. 25, the conductive gasket 570 can be positioned between the outboard housing 534 and the motor 504 (e.g., motor connection port 582). The conductive gasket 570 can be composed of any types of conductive material, such as similar to or different from the o-ring 550, outboard seal 536, etc. The conductive gasket 570 may have a substantially similar geometry to the outboard housing 534 and the inboard housing 532, where excess material from the conductive gasket 570 does not extend past the outboard housing 534 and the inboard housing 532. As shown in at least FIG. 26, the conductive gasket 570 includes one or more apertures 575. The apertures 575 are configured to receive the fasteners (e.g., 534b and/or screws 565) therethrough, such as for coupling the conductive gasket 570 to at least one of the housing 532, 534 and/or the motor connection port 582. In some embodiments, the conductive gasket 570 may be coupled to the housings 532, 534 and/or the motor connection port 582 via alternative methods (e.g., adhesive, bracket, etc.). The conductive gasket 570 may provide a level of EMI protection to the busbar connector assembly 500.

As shown in FIG. 26, detaching the conductive gasket 570 can expose the motor connection port 582. The motor connection port 582 can be configured to interface with the busbar connector assembly 500 (e.g., configured for electrical contact with the busbar 545). In some embodiments, the conductive gasket 570 can be secured or coupled to at least a portion of or surrounding the motor connection port 582 via one or more recessed portions, such as cavities 580a, 580b, 580c, and/or 580d (e.g., referred to collectively as cavity/cavities 580). The conductive gasket 570 can be an interposing layer interposed between the motor 504 (e.g., motor connection port 582) and at least one of the outboard housing 534 or the inboard housing 532. For instance, the conductive gasket 570 can include one or more protrusions (not shown) configured to provide friction fitting with the one or more cavities 580. In this case, the one or more apertures 575 may be a pass-through (a passage or conduit) for fasteners to secure at least one of the housings 532, 534 to the motor connection port 582 through the apertures 575 and onto (e.g., aperture of) the motor connection port 582, for example. By coupling the busbar 545 to the motor connection port 582, the electrical connection between the battery pack 205 and the motor 504 can be established.

Although this description may discuss a specific order of steps, the order of the steps may differ from what is outlined. Also, two or more steps may be performed concurrently or with partial concurrence.

As utilized herein, the terms “approximately”, “about”, “substantially”, and similar terms are intended to have a broad meaning in harmony with the common and accepted usage by those of ordinary skill in the art to which the subject matter of this disclosure pertains, and are generally understood to include a variation within about plus or minus 10% of any stated value. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments.

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

The construction and arrangement of the busbar connector as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. An electric vehicle, comprising:
at least one tractive element;
a battery pack including a plurality of battery cells;
an in-wheel hub motor coupled to the at least one tractive element and electrically coupled to the battery pack; and
a busbar assembly configured to electrically couple the motor to the battery pack, the busbar assembly comprising:
a busbar;
a cable electrically coupled to the busbar; and
an inverter electrically coupled to the cable and configured to convert power supplied from the battery pack to the motor,
wherein the busbar assembly further comprises a bracket configured to mount the cable to a knuckle of the electric vehicle and position the cable at a fixed or variable angle.

2. The electric vehicle of claim 1, wherein the cable is configured to be positioned with a clearance from another object within a chassis of the vehicle.

3. The electric vehicle of claim 1, wherein the busbar assembly further comprises at least one crimp coupled to at least one portion of the cable, wherein the at least one crimp is configured to isolate the at least one portion of the cable from direct contact with a plurality of components of the electric vehicle to prevent axial load damage.

4. The electric vehicle of claim 1, wherein the busbar assembly further comprises:
an outboard housing coupled to the motor, the outboard housing comprising at least one cavity configured to position the busbar for coupling with the motor; and
an inboard housing coupled to the outboard housing,
wherein the busbar is interposed between the outboard housing and the inboard housing.

5. The electric vehicle of claim 4, wherein a proximal end of the cable is positioned laterally from the outboard housing and the inboard housing by a perpendicular extension of the busbar.

6. The electric vehicle of claim 4, the busbar assembly further comprises:
a first seal coupled to the outboard housing and configured to surround the busbar, wherein the first seal defines an opening of the at least one cavity of the outboard housing; and
a second seal coupled to the first seal and configured to encapsulate the busbar with the first seal.

7. The electric vehicle of claim 1, wherein the busbar assembly further comprises at least one conductive o-ring coupled to a portion of the cable and positioned proximate to the busbar.

8. The electric vehicle of claim 1, further comprising a motor connection port configured to interface with the busbar assembly, and
wherein the busbar assembly further comprises a conductive gasket having an opening surrounding the motor connection port, the conductive gasket interposed between the motor and at least one of an outboard housing or an inboard housing.

9. The electric vehicle of claim 1, wherein the motor is a three-phase motor having a three-phase cable system, and wherein the busbar assembly comprises:
a plurality of cables coupled to a plurality of busbars, respectively, configured to electrically couple the motor to the three-phase cable system of the three-phase motor.

10. The electric vehicle of claim 9, wherein the three-phase cable system includes a rigid cable shield configured to insulate the plurality of cables from one another.

11. A busbar assembly comprising:
a plurality of busbars;
a plurality of cables electrically respectively coupled to the plurality of busbars;
a bracket configured to mount the plurality of cables to a knuckle of the electric vehicle; and
an inverter electrically coupled to the plurality of cables,
wherein the busbar assembly is configured to electrically couple a motor to a battery pack of an electric vehicle, and
wherein the inverter is configured to convert power supplied from the battery pack to the motor.

12. The busbar assembly of claim 11, wherein the bracket is configured to position the plurality of cables at a fixed angle.

13. A busbar assembly of claim 11, further comprising a plurality of crimps coupled to at least one portion of the plurality of cables, wherein the plurality of crimps are configured to isolate the at least one portion of the plurality of cables from direct contact with a plurality of components of the electric vehicle to prevent axial load damage.

14. A method, comprising:
coupling a busbar assembly to a battery pack of an electric vehicle; and
coupling the busbar assembly to an in-wheel hub motor of the electric vehicle, wherein the motor and the battery pack are electrically coupled via the busbar assembly, the busbar assembly comprising:
a busbar; and
a cable electrically coupled to the busbar, and arranged so as to have a fixed or variable angle with respect to a bracket to which the cable is mounted; and
an inverter electrically coupled to the cable and configured to convert power supplied from the battery pack to the motor.

15. The method of claim 14, further comprising:
coupling at least one crimp to at least one portion of the cable, wherein the at least one crimp is configured to isolate the at least one portion of the cable from direct contact with a plurality of components of the electric vehicle to prevent axial load damage.
